(19) United States
(12) Patent Application Publication
(10) Pub. No.: US 2019/0067721 A1
(43) Pub. Date: Feb. 28, 2019

(54) ELECTRODE BINDER USING ALCOHOL BASED SOLVENT FOR POLYMER ELECTROLYTE MEMBRANE FUEL CELL AND METHOD FOR PREPARING THE SAME

(71) Applicant: KOREA INSTITUTE OF SCIENCE AND TECHNOLOGY, Seoul (KR)

(72) Inventors: Hyoung-Juhn KIM, Seoul (KR); Jieon CHAE, Seoul (KR); So Young LEE, Seoul (KR); Suk Woo NAM, Seoul (KR); Jong Hyun JANG, Seoul (KR); Sung Jong YOO, Seoul (KR); Jin Young KIM, Seoul (KR); Hyun Seo PARK, Seoul (KR)

(21) Appl. No.: 15/869,031

(22) Filed: Jan. 12, 2018

(30) Foreign Application Priority Data
Aug. 23, 2017 (KR) 10-2017-0106520

(51) Int. Cl. H01M 8/1004; H01M 8/1041; H01M 8/0239; C08L 101/06; C08L 81/06

(52) U.S. Cl. CPC H01M 8/1004; H01M 8/1041; H01M 2300/0082; C08L 101/06; C08L 81/06; H01M 8/0239

(57) ABSTRACT

Disclosed is an alcohol mixture typed hydrocarbon based electrode binder for a polymer electrolyte membrane fuel cell. The binder may be directly applied to a hydrocarbon based electrolyte membrane of the same kind, and may exhibit a superior fuel cell performance over conventional hydrocarbon polymer binders using an organic solvent.

### CROSS-REFERENCE TO RELATED APPLICATION

This application claims priority to Korean Patent Application No. 10-2017-0106520, filed on Aug. 23, 2017, and all the benefits accruing therefrom under 35 U.S.C. § 119, the contents of which in its entirety are herein incorporated by reference.

### BACKGROUND OF THE INVENTION

### 1. Field

The present disclosure relates to an electrode binder using an alcohol based solvent for a polymer electrolyte membrane fuel cell and a method for preparing the same, an electrode and a membrane electrode assembly for a polymer electrolyte fuel cell using the same, a fuel cell comprising the membrane electrode assembly, and a method for preparing the same.

### Description about National Support Research and Development

This study is made by the support of a project for development of technology for coping with climate changes, implemented by the National Research Foundation of Korea of the Ministry of Science, ICT and Future Planning of the Republic of Korea under the supervision of the Korea Institute of Science and Technology. The research project is titled “Development of Technology for Preparation of Low-cost Electrolyte Membrane and Membrane Electrode Assembly for High Temperature PEMFC (Project number: 2016937136).

### 2. Description of the Related Art

An electrode binder for fuel cells is used for electrodes of a membrane electrode assembly of polymer electrolyte fuel cells. The electrode binder uniformly disperses a catalyst layer and fixes a catalyst layer and an electrolyte membrane. It also serves as a delivery path allowing protons generated in the anode to be conducted to the cathode.

Therefore, an electrode binder suitable for fuel cells should have not only ion conduction properties, but also good interfacial bonding with an electrolyte membrane. It should also have sufficient gas permeability since it constitutes an electrode.

The binder which has been commonly used up to now is perfluorosulfonic acid (PFSA) ionomer, which is also used as a component of electrolyte membranes (Nafion membranes). However, PFSA ionomer is one of the limiting factors for the commercialization of fuel cells because its synthesis is expensive. Therefore, studies have been actively conducted on hydrocarbon polymer ionomer or hydrocarbon polymer electrolyte membranes in order to replace it.

However, conventional hydrocarbon polymer electrode binders are prepared as a polymer solution by dissolving the polymer using an organic solvent such as dimethylacetamide (DMAc), dimethylsulfoxide (DMSO), dimethylformamide (DMF), and methylpyrrolidone (NMP). Then, a membrane electrode assembly is prepared from the solution using a decal process or a screen-printing process.

However, in case where a hydrocarbon electrode binder based on an organic solvent is used together with an electrolyte membrane of the same kind, the electrolyte membrane may be dissolved by a residual organic solvent used in the preparation of the electrode binder, resulting in formation of pinholes, in the preparation of a membrane electrode assembly. This causes a big problem of deterioration of the durability of the fuel cell, which makes it difficult to use the hydrocarbon electrode binder itself.

### SUMMARY

In one aspect, the object of embodiments of the present invention is to form an electrode in a polymer electrolyte membrane fuel cell by directly applying a hydrocarbon based binder to a hydrocarbon based electrolyte membrane of the same kind using, for example, the CCM method, without the problems of pinhole formation in the electrolyte membrane, resultant deterioration of the durability of the fuel cell, etc.

In another aspect, the object of embodiments of the present invention is to achieve good interfacial bonding between an electrode and a membrane by allowing to apply a hydrocarbon based binder to a hydrocarbon based electrolyte membrane of the same kind, and also to facilitate handling and preparation by using an alcohol.

In yet another aspect, the object of embodiments of the present invention is to reduce the production cost of fuel cells by allowing to configure both an electrode binder and an electrolyte membrane with a hydrocarbon based polymer of the same kind.

Exemplary embodiments of the present invention provide an electrode binder composition for a polymer electrolyte membrane fuel cell, comprising an alcohol based solvent comprising water and an alcohol; and a hydrocarbon based polymer binder.

Other exemplary embodiments of the present invention provide a catalyst slurry for a polymer electrolyte membrane fuel cell, comprising a catalyst, an alcohol based solvent comprising water and an alcohol; and a hydrocarbon based polymer binder.

Other exemplary embodiments of the present invention provide a method for preparing an electrode binder for a polymer electrolyte membrane fuel cell, comprising: preparing an alcohol based solvent comprising water and an alcohol; and mixing the alcohol based solvent with a hydrocarbon based polymer binder.

Other exemplary embodiments of the present invention provide a method for preparing a catalyst slurry for a polymer electrolyte membrane fuel cell, comprising: preparing an alcohol based solvent comprising water and an alcohol; mixing the alcohol based solvent with a hydrocarbon based polymer binder to prepare an electrode binder composition; and mixing the electrode binder composition with a catalyst to prepare a catalyst slurry.

Other exemplary embodiments of the present invention provide a method for preparing a membrane electrode assembly for a polymer electrolyte membrane fuel cell, comprising: directly coating the catalyst slurry for a polymer electrolyte membrane fuel cell on a hydrocarbon based electrolyte membrane of the same kind as the hydrocarbon polymer binder.

Other exemplary embodiments of the present invention provide an electrode for a polymer electrolyte membrane fuel cell, prepared from a catalyst slurry for a polymer electrolyte membrane fuel cell comprising a catalyst; an alcohol based solvent comprising water and an alcohol; and a hydrocarbon based polymer binder.

Other exemplary embodiments of the present invention provide a membrane electrode assembly for a polymer electrolyte membrane fuel cell, prepared by directly coating a catalyst slurry for a polymer electrolyte membrane fuel cell on a hydrocarbon based electrolyte membrane of the same kind as the hydrocarbon based polymer binder.

Other exemplary embodiments of the present invention provide a polymer electrolyte membrane fuel cell comprising the membrane electrode assembly.

### BRIEF DESCRIPTION OF THE DRAWINGS

The above and other aspects, features and advantages of the disclosed example embodiments will be more apparent from the following detailed description taken in conjunction with the accompanying drawings in which:

FIG. 1A shows a photograph of the alcohol mixture typed electrode binder according to Example of the present invention.

FIG. 1B shows a photograph of the polymer solution typed electrode binder using an organic solvent of Comparative Example.

FIG. 2 shows the evaluation results of the fuel cell performance of the polymer solution typed electrode binder prepared in Comparative Example of the present invention.

FIG. 3A shows evaluation results of the fuel cell performance of the alcohol mixture typed electrode binder prepared in Example of the present invention, illustrating the result of a supply of stoichiometric hydrogen and air.

FIG. 3B shows evaluation results of the fuel cell performance of the alcohol mixture typed electrode binder prepared in Example of the present invention, illustrating the result of a supply of hydrogen and oxygen.

FIG. 4 shows evaluation results of the performance of a fuel cell in which the alcohol mixture typed electrode binder prepared in Example of the present invention has been applied to a hydrocarbon electrolyte membrane of the same kind.

### DETAILED DESCRIPTION

Exemplary embodiments are described more fully hereinafter. The invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the description, details of features and techniques may be omitted to more clearly disclose exemplary embodiments.

### Term Definition

In the present disclosure, the term “hydrocarbon based polymer binder” may encompass a partially fluorinated hydrocarbon based polymer binder.

In the present disclosure, the term “hydrocarbon based polymer of the same kind” refers that a main chain of a polymer binder has the same structure as a main chain of an electrolyte of the electrolyte membrane.

### Description of Exemplary Embodiments

Hereinafter, exemplary embodiments of the present invention will be described in detail.

The present inventors have made it possible to directly form an electrode on a hydrocarbon based electrolyte membrane of the same kind as a hydrocarbon based polymer binder using the CCM (catalyst coated membrane) method, by preparing an alcohol mixture typed binder using an alcohol based solvent instead of a conventional organic solvent.

Specifically, in exemplary embodiments of the present invention, provided is an electrode binder composition for a polymer electrolyte membrane fuel cell, comprising an alcohol based solvent comprising water and an alcohol; and a hydrocarbon based polymer binder.

In other exemplary embodiments of the present invention, provided is a catalyst slurry for a polymer electrolyte membrane fuel cell, comprising an alcohol based solvent comprising water and an alcohol; and a hydrocarbon based polymer binder.

Further, in other exemplary embodiments of the present invention, provided is a method for preparing an electrode binder composition for a polymer electrolyte membrane fuel cell, comprising: preparing an alcohol based solvent comprising water and an alcohol; and mixing the alcohol based solvent with a hydrocarbon based polymer binder.

Further, in other exemplary embodiments of the present invention, provided is a method for preparing a catalyst slurry for a polymer electrolyte membrane fuel cell, comprising: preparing an alcohol based solvent comprising water and an alcohol; mixing the alcohol based solvent with a hydrocarbon based polymer binder to prepare an electrode binder composition; and mixing the electrode binder composition with a catalyst to prepare a catalyst slurry.

In one exemplary embodiment, the alcohol is not particularly limited, but it preferably has a boiling point of less than 150° C., for example, 100±30° C. In a non-limiting example, examples of the alcohol may include 1-propanol, isopropanol and ethanol.

In a non-limiting example, the alcohol may be, for example, 1-propanol represented by Formula 1. For reference, the boiling point of 1-propanol is 97° C.

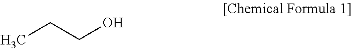

In one exemplary embodiment, the alcohol may be mixed with water, for example, distilled water, to produce an alcohol based solvent.

The alcohol is mixed well with water, because water is readily miscible with alcohol and has a boiling point of less than 100° C. In addition, water is preferable because it may disperse hydrocarbon based polymers, particularly polymers substituted with a sulfonic acid group which are used in combination therewith

In a non-limiting example, 5 to 95% by weight of an alcohol such as 1-propanol etc. is mixed with 95 to 5% by weight of water. When the ratio is outside this range, the polymer may precipitate.

A hydrocarbon based polymer binder is added to the resultant alcohol based solvent, and the mixture is heated to a room temperature or higher with stirring to prepare a binder.

In one exemplary embodiment, for example, sulfonated polyarylene ether sulfone may be used as the hydrocarbon polymer binder, although not particularly limited thereto. Further, sulfonated polyimide, polysulfone, polyether sulfone, polyarylene ether ketone, polyether ether ketone, polybenzimidazole, polybenzoxazole, polybenzothiazole, polyphosphazene, and polymer materials made of copolymers and blends thereof may be used as the hydrocarbon based polymer binder.

In a non-limiting example, the concentration of a polymer binder in the mixture of an alcohol based solvent and a binder may be, for example, 1 to 20 wt %, for example 5 wt %. When the solution has a concentration within the above range, the viscosity of the solution may be about 1000 cp or less, which makes it easy to prepare catalyst slurry.

In a non-limiting example, for example, a hydrocarbon polymer binder may be added to an alcohol based solvent and stirred while heating to a temperature higher than room temperature, for example, to 40 to 60° C. If the temperature is higher than 60° C., it may promote a volatilization of the alcohol based solvent. The solvent and the polymer are mixed over time, resulting in an opaque milky color.

Then, the resultant electrode binder, together with a commercial catalyst, may be prepared into catalyst ink or catalyst slurry, and an electrode layer may be formed on a hydrocarbon based electrolyte membrane by the CCM (catalyst coated membrane) method to form a membrane electrode assembly. Then, a fuel cell may be constructed therefrom.

Thus, in other exemplary embodiments of the present invention, provided is a method for preparing a membrane electrode assembly for a polymer electrolyte membrane fuel cell, comprising: directly coating the catalyst slurry for a polymer electrolyte membrane fuel cell on a hydrocarbon based electrolyte membrane of the same kind as the hydrocarbon based polymer binder using the catalyst coated membrane (CCM) method.

Further, in other exemplary embodiments of the present invention, provided is an electrode for a polymer electrolyte membrane fuel cell, prepared from a catalyst slurry for a polymer electrolyte membrane fuel cell comprising a catalyst; an alcohol based solvent comprising water and an alcohol; and a hydrocarbon based polymer binder.

In addition, in other exemplary embodiments of the present invention, provided is a membrane electrode assembly for a polymer electrolyte membrane fuel cell, prepared by directly coating a catalyst slurry for a polymer electrolyte membrane fuel cell on a hydrocarbon electrolyte membrane of the same kind as the polymer binder, using the catalyst coated membrane (CCM) method.

In addition, in other exemplary embodiments of the present invention, a polymer electrolyte membrane fuel cell comprising the membrane electrode assembly is provided.

Hereinafter, a specific example according to exemplary embodiments of the present invention will be described in more detail. It should be understood, however, that the invention is not limited to the following example, but that various changes may be made without departing from the scope of the appended claims. It is to be understood that the following example is provided merely to make the disclosure complete and to facilitate the practice of the invention by those skilled in the art.

### SYNTHESIS EXAMPLES

### Example

### Preparation of an Electrode Binder using an Alcohol Based Solvent

0.05 g of polyarylene ether sulfone polymer substituted with a sulfonic acid group is added to a solvent obtained by mixing 0.633 g of 1-propanol and 0.317 g of distilled water, and the mixture is stirred at 40° C. As a result, a mixture having an opaque milk color is prepared.

### Comparative Example

### Preparation of an Electrode Binder using an Organic Solvent

The same binder preparation method as the above example is used except that 0.95 g of an organic solvent (dimethylacetamide) is used instead of an alcohol mixture solvent, and that 0.05 g of the same polymer is dissolved at 60° C. with stirring. As a result, a pale yellow transparent polymer solution is prepared.

### Fuel Cell Construction and Evaluation of Characteristics Thereof

The respective binders of Example and Comparative Example are used. The composition of the catalyst electrode slurry is as follows: 64.3 mg of 46.7 wt % Pt/C, 12 ml of isopropanol, and 321.2 mg of a binder. Nafion® NR212 and a polymer electrolyte membrane of poly(arylene ether sulfone) substituted with a sulfonic acid group is used as electrolyte membranes. An electrode assembly is prepared by coating a catalyst layer with an area of 25 cm² on an electrolyte membrane using the CCM method so that the amount of platinum catalyst per unit area is 0.4 mg/cm². The performance of the fuel cell is evaluated by measuring the voltage at a current while increasing the current from 0 A by 0.5 A, and expressing the measurements as current densities and power densities.

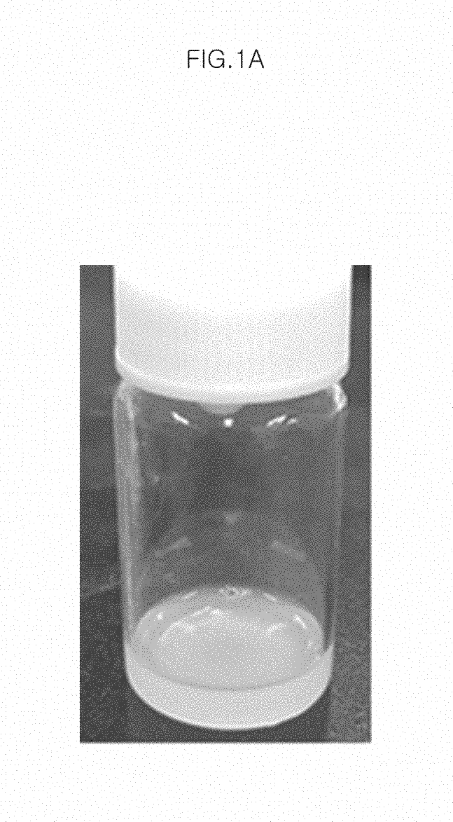

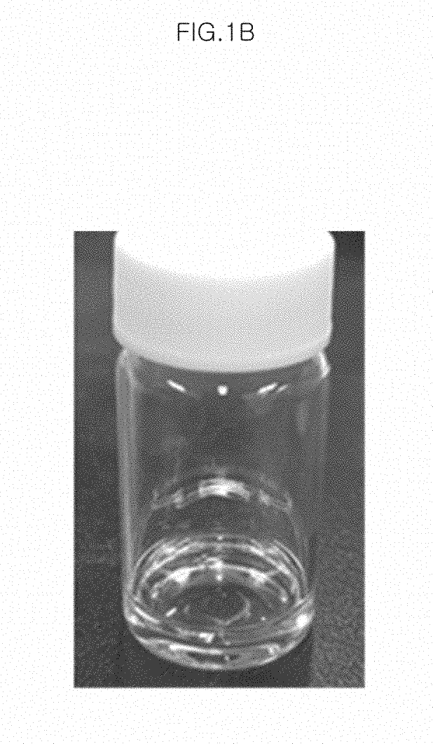

FIGS. 1A and 1B show the photographs of the electrode binders with a concentration of 5 wt % of Example and Comparative Example of the present invention, prepared using an alcohol based solvent and an organic solvent, respectively.

The alcohol mixture typed binder of Example (FIG. 1A) exhibits an opaque milky color, and the binder using an organic solvent of Comparative Example (FIG. 1B), is prepared as a pale yellow transparent polymer solution.

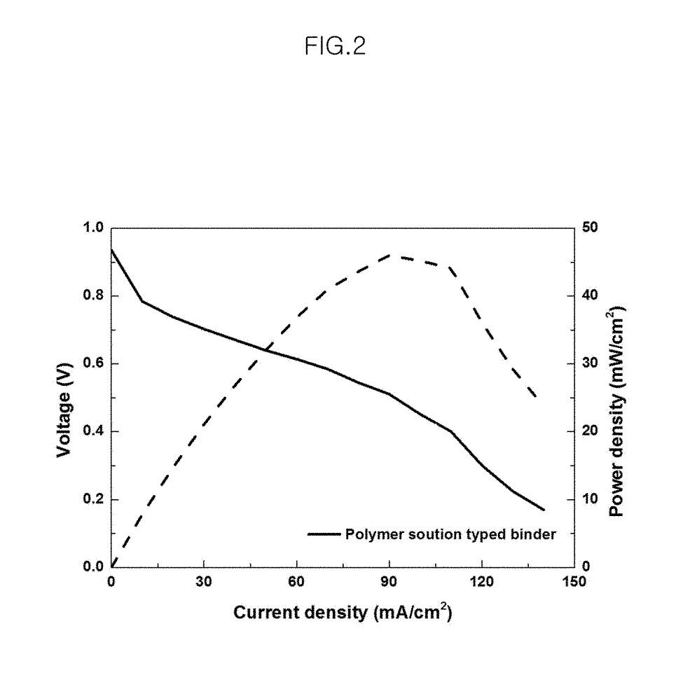

FIG. 2 is a current-voltage polarization curve drawn by evaluating the fuel cell performance of the polymer solution typed binder of Comparative Example.

The fuel cell is operated at a cell temperature of 65° C. and a relative humidity of 95% with a supply of stoichiometric hydrogen and air. The results show that the current density is 62 mA/cm² at 0.6 V and the maximum power density is 46 mW/cm².

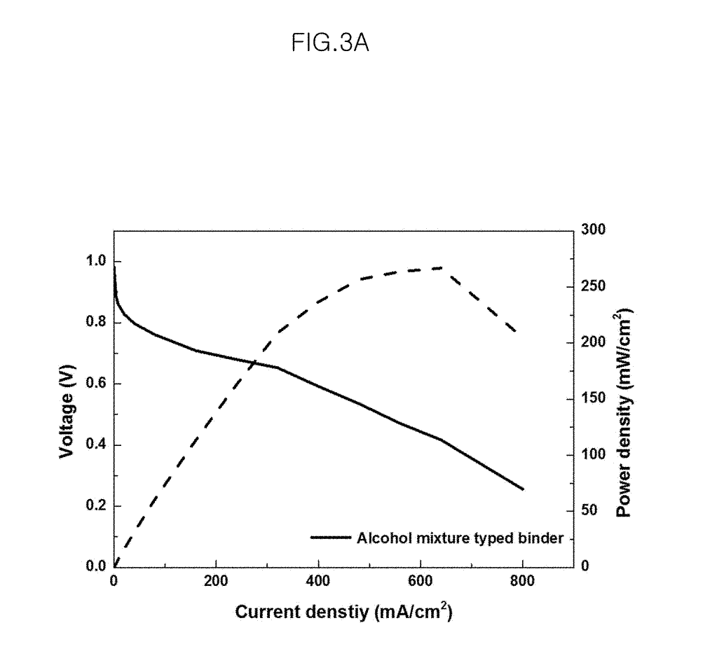

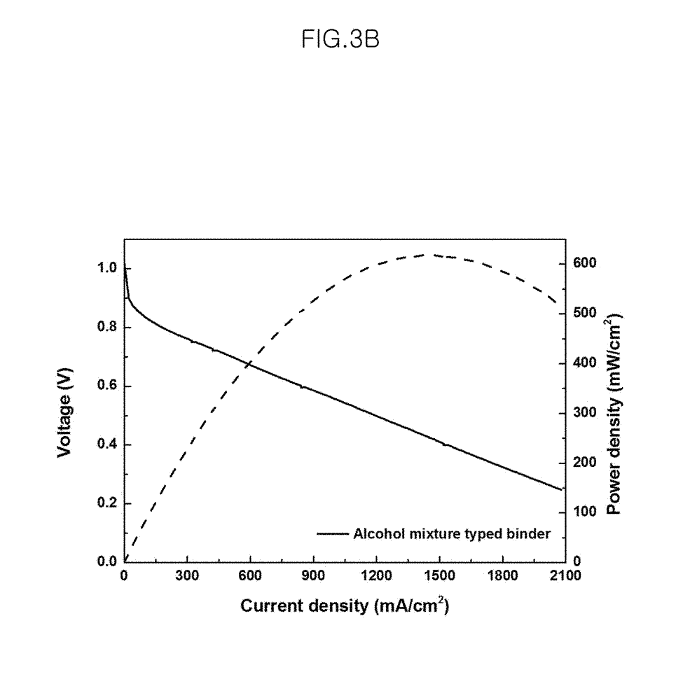

FIGS. 3A and 3B are current-voltage polarization curves drawn by evaluating the fuel cell performance of the alcohol mixture typed binder prepared in Example of the present invention.

The fuel cell is operated at a cell temperature of 80° C. and a relative humidity of 95% with a supply of stoichiometric hydrogen and air. The results shows that the current density is 385 mA/cm² at 0.6 V and the maximum power density is 267 mW/cm² (FIG. 3A).

On the other hand, when oxygen is sufficiently supplied instead of air, the current density is 840 mA/cm² at 0.6 V and the maximum power density is 618 mW/cm² (FIG. 3B).

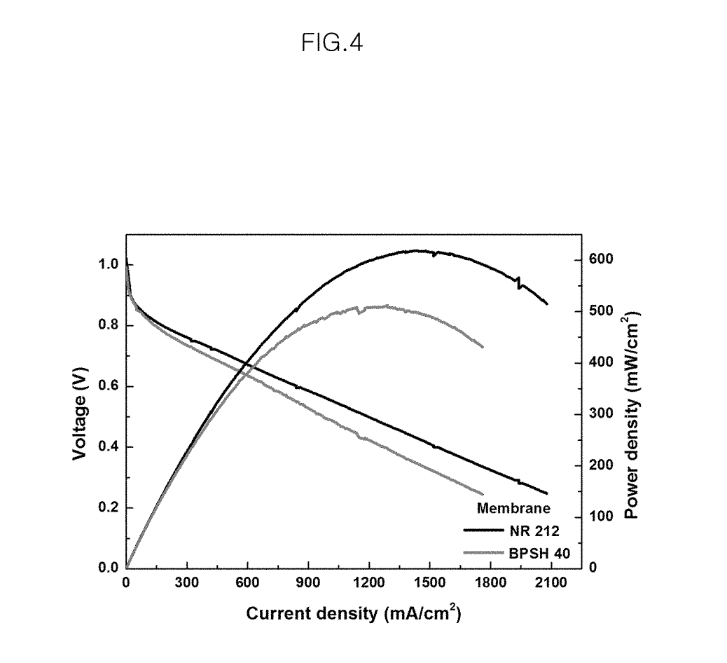

FIG. 4 shows the comparison results of the performance of fuel cells obtained by applying the alcohol mixture typed binder prepared in Example of the present invention to a Nafion electrolyte membrane from DuPont, which is a commercial membrane, and a hydrocarbon membrane of polyarylene ether sulfone substituted with a sulfonic acid, respectively.

The fuel cell is operated at a cell temperature of 80° C. and a relative humidity of 95% with a supply of hydrogen and oxygen. The results show that when the prepared electrode binder is applied to a hydrocarbon electrolyte membrane of the same kind, it exhibits the maximum power density of about 500 mW/cm² although it has a power density about 100 mW/cm² lower than a case where a Nafion electrolyte membrane is applied, which in turn demonstrates that an excellent performance is achieved in the Example.

According to exemplary embodiments of the present invention, a hydrocarbon based electrode binder mixed with an alcohol may achieve good bonding without formation of pinholes, etc. when applied to a hydrocarbon based electrolyte membrane of the same kind, and it is easy to handle and prepare. When an organic solvent is used, there is a possibility of pinhole formation, in which an electrolyte membrane may be partially dissolved, due to the residual organic solvent. However, when alcohol is used, it does not dissolve the electrolyte membrane. In addition, the use of alcohol may facilitate handling and preparation because it has a higher volatility than organic solvents.

Accordingly, it is possible to apply the catalyst coated membrane (CCM) method, in which an electrode layer is directly formed on a hydrocarbon based electrolyte membrane of the same kind using a hydrocarbon based electrode binder, without using an organic solvent. In addition, there is no problem of formation of pinholes in the electrolyte membrane of a polymer electrolyte membrane fuel cell or the accompanying deterioration of the durability of the fuel cell. Further, it is possible to achieve a superior fuel cell performance over the case of using a polymer solution typed binder using an organic solvent.

While the present invention has been described with respect to the specific embodiments, it will be apparent to those skilled in the art that various changes and modifications may be made without departing from the spirit and scope of the invention as defined in the following claims.

What is claimed is:

1. An electrode binder composition for a polymer electrolyte membrane fuel cell, comprising an alcohol based solvent comprising water and an alcohol; and a hydrocarbon based polymer binder.

2. The electrode binder composition for a polymer electrolyte membrane fuel cell according to claim 1,
wherein the alcohol has a boiling point of less than 150° C.

3. The electrode binder composition for a polymer electrolyte membrane fuel cell according to claim 2,
wherein the alcohol is one or more selected from the group consisting of 1-propanol, isopropanol, and ethanol.

4. The electrode binder composition for a polymer electrolyte membrane fuel cell according to claim 1,
wherein the hydrocarbon polymer binder comprises a partially fluorinated hydrocarbon based polymer binder.

5. The electrode binder composition for a polymer electrolyte membrane fuel cell according to claim 1,
wherein the hydrocarbon polymer binder is a polymer selected from the group consisting of sulfonated polyarylene ether sulfone, sulfonated polyimide, polysulfone, polyether sulfone, polyarylene ether ketone, polyether ether ketone, polybenzimidazole, polybenzoxazole, polybenzothiazole, and polyphosphazene, a copolymer of the polymer, or a mixture of two or more of the polymer.

6. The electrode binder composition for a polymer electrolyte membrane fuel cell according to claim 1,
wherein the alcohol based solvent contains, by weight, 5 to 95% of an alcohol and 95 to 5% of water.

7. The electrode binder composition for a polymer electrolyte membrane fuel cell according to claim 1,
wherein the mixture of an alcohol based solvent and a hydrocarbon based polymer binder contains 1 to 20 wt % of the hydrocarbon based polymer binder.

8. A catalyst slurry for a polymer electrolyte membrane fuel cell, comprising a composition of claim 1; and a catalyst.

9. A method for preparing an electrode binder composition for a polymer electrolyte membrane fuel cell, comprising:
preparing an alcohol based solvent comprising water and an alcohol; and
mixing the alcohol based solvent with a hydrocarbon based polymer binder.

10. The method for preparing an electrode binder composition for a polymer electrolyte membrane fuel cell according to claim 9,
wherein the hydrocarbon polymer binder is added to the alcohol based solvent with stirring and heating to a temperature higher than room temperature and less than 60° C.

11. A method for preparing a catalyst slurry for a polymer electrolyte membrane fuel cell, comprising:
preparing an alcohol based solvent comprising water and an alcohol;
mixing the alcohol based solvent with a hydrocarbon based polymer binder to prepare an electrode binder composition; and
mixing the electrode binder composition with a catalyst to prepare a catalyst slurry.

12. A method for preparing a membrane electrode assembly for a polymer electrolyte membrane fuel cell, comprising:
directly coating the catalyst slurry for a polymer electrolyte membrane fuel cell according to claim 8 on a hydrocarbon based electrolyte membrane of the same kind as the hydrocarbon based polymer binder of the catalyst slurry.

13. The method for preparing a membrane electrode assembly for a polymer electrolyte membrane fuel cell according to claim 12,
wherein the direct coating is performed using a catalyst coated membrane (CCM) method.
